(19) United States
(12) Patent Application Publication
(10) Pub. No.: US 2013/0038630 A1
(43) Pub. Date: Feb. 14, 2013

(54) IMAGE DRAWING DEVICE AND IMAGE DRAWING METHOD

(71) Applicant: Makoto Otsuru, Tokyo (JP)

(72) Inventor: Makoto Otsuru, Tokyo (JP)

(73) Assignee: Mitsubishi Electric Corporation, Tokyo (JP)

(21) Appl. No.: 13/641,320

(22) PCT Filed: Apr. 15, 2010
(86) PCT No.: PCT/JP2010/002738

§ 371 Date: Oct. 15, 2012

(51) Int. Cl. G09G 5/00

(52) U.S. Cl. 345/629

(57) ABSTRACT

Disclosed is an image drawing device including a gradation drawing unit for generating two background drawing objects which are to be located in a lower layer than a gradation target drawing object and drawing the gradation target drawing object on one of the background drawing objects while carrying out an antialiasing process between the one of the background drawing objects and the gradation target drawing object to generate a source image, and combining the source image on a basis of an alpha map to generate a destination image.

### FIELD OF THE INVENTION

The present invention relates to an image drawing device for and an image drawing method of performing an image process accompanied by gradation on a drawing object.

### BACKGROUND OF THE INVENTION

Conventionally, a method of using an alpha map is known as a method of implementing a gradation effect on a drawing object. This method includes a step of generating an image on which gradation is performed by combining two images on the basis of a values set to an alpha map. This method using the alpha map can also be applied to a vector map drawing for use in a navigation device. Further, as a gradation method for use in map drawing, patent reference 1 discloses a technique of performing gradation on a road map in such a way that the background color of the road map becomes close to a color similar to the color of roads of an arbitrary type with distance from the current position on the road map, thereby making roads of the arbitrary type located distant from the current position on the road map not noticeable, and hence making the road map legible.

### Related Art Document

### Patent Reference

Patent reference 1: Japanese Unexamined Patent Application Publication No. Hei 7-262490

### SUMMARY OF THE INVENTION

Because the conventional image drawing method is constructed as above, when gradation is desired to be performed on a specific drawing object (roads or the like), the antialiasing process cannot be performed between the specific drawing object and a background drawing object (a background or the like) which serves as a background on which the specific drawing object is located, a problem with the conventional image drawing method is that jaggies are noticeable in the drawn image. This is because when combining the specific drawing object and the background drawing object on the basis of α values, the antialiasing process cannot be carried out between them.

The present invention is made in order to solve the above-mentioned problem, and it is therefore an object of the present invention to provide an image drawing device and an image drawing device capable of performing gradation on a specific one of drawing objects on which an antialiasing process is performed.

In accordance with the present invention, there are provided an image drawing device for and an image drawing device of generating two background drawing objects which are to be located in a lower layer than a gradation target drawing object and drawing the gradation target drawing object on one of the background drawing objects while carrying out an antialiasing process between the one of the background drawing objects and the gradation target drawing object to generate a source image, and combining the source image on the basis of an alpha map to generate a destination image.

Because the image drawing device and the image drawing device in accordance with the present invention are constructed in such a way as to generate two background drawing objects which are to be located in a lower layer than a gradation target drawing object and drawing the gradation target drawing object on one of the background drawing objects while carrying out an antialiasing process between the one of the background drawing objects and the gradation target drawing object to generate a source image, and combining the source image on the basis of an alpha map to generate a destination image, gradation can be performed on the source image on which the antialiasing process has been performed, and a gradation image in which jaggies are not noticeable can be provided.

### BRIEF DESCRIPTION OF THE FIGURES

FIG. 1 is a block diagram showing an image drawing device in accordance with Embodiment 1 of the present invention;

FIG. 2 is a flow chart showing the operation of a gradation drawing unit of the image drawing device in accordance with Embodiment 1 of the present invention;

FIG. 3 is an explanatory drawing showing a process carried out by the gradation drawing unit of the image drawing device in accordance with Embodiment 1 of the present invention; and

FIG. 4 is an explanatory drawing showing a concrete example of the process carried out by the gradation drawing unit of the image drawing device in accordance with Embodiment 1 of the present invention.

### EMBODIMENTS OF THE INVENTION

Hereafter, in order to explain this invention in greater detail, the preferred embodiments of the present invention will be described with reference to the accompanying drawings.

### Embodiment 1

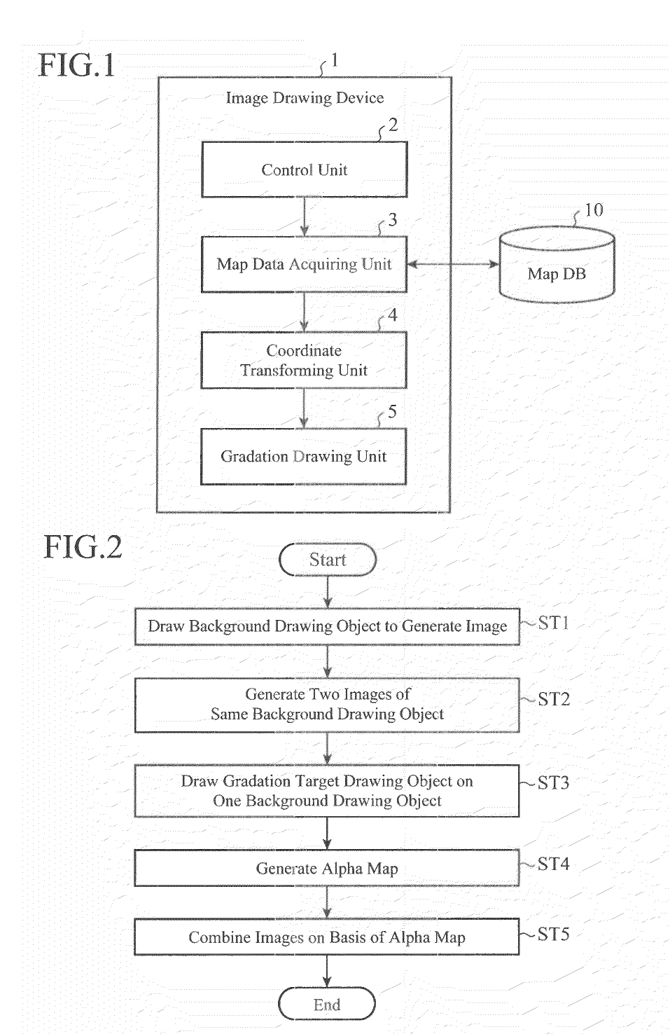

FIG. 1 is a block diagram showing the structure of an image drawing device in accordance with Embodiment 1. The image drawing device 1 is comprised of a control unit 2, a map data acquiring unit 3, a coordinate transforming unit 4, and a gradation drawing unit 5. The control unit 2 determines parameters required for map drawing, the parameters including a drawing area and a display scale, on the basis of input information inputted thereto from outside the image drawing device. The map data acquiring unit 3 acquires map data about a map in the drawing area from a map database 10 which is an external storage area on the basis of the parameters determined by the control unit 2. The map data acquired by the map data acquiring unit 3 are categorized in accordance with the types of objects, such as roads and backgrounds, and are expressed by vector data. In this embodiment, the vector data are expressed by latitudes and longitudes and in a coordinate system which is normalized in a map area, and cannot be displayed on a display device just as they are.

The coordinate transforming unit 4 transforms the map data expressed in the map coordinate system which are acquired by the map data acquiring unit 3 into data in a device coordinate system which can be displayed on the display device. The gradation drawing unit 5 carries out gradation drawing by using the data into which the map data are transformed by the coordinate transforming unit 4.

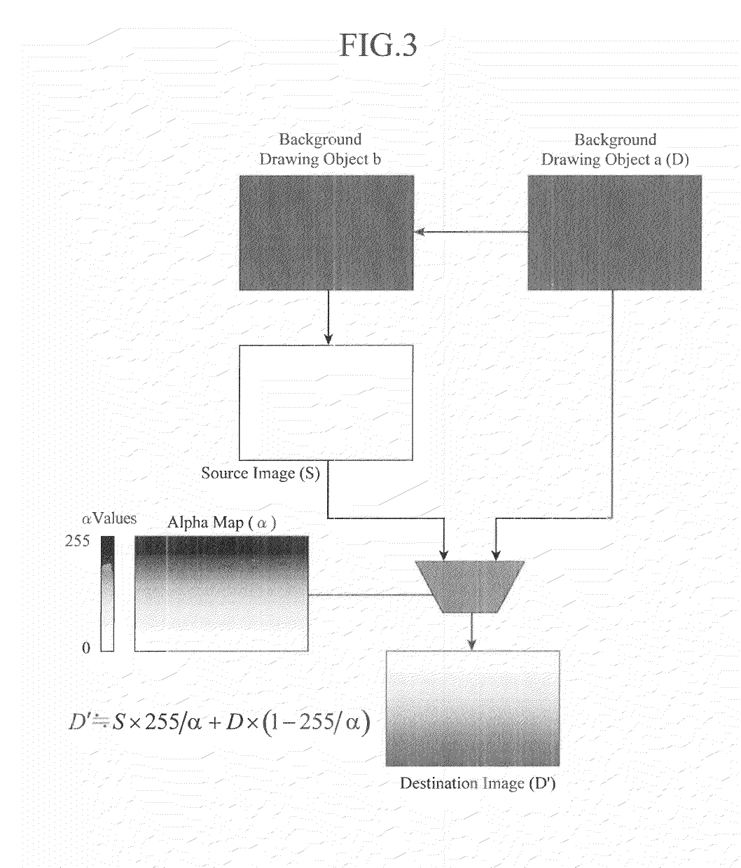

Next, the operation of the gradation drawing unit 5 will be explained by using FIGS. 2 and 3. FIG. 2 is a flow chart showing the operation of the gradation drawing unit, and FIG. 3 is an explanatory drawing showing the process carried out by the gradation drawing unit. In the following explanation, a drawing object on which gradation is to be performed is referred to as a gradation target drawing object, and a drawing object which is located in a lower layer than the gradation target drawing object and on which no gradation is performed is referred to as a background drawing object.

The gradation drawing unit 5 draws a background drawing object to generate an image of the background drawing object (step ST1 of FIG. 2). The gradation drawing unit then makes a copy of the background drawing object which is imaged in step ST1 to generate two images of the same background drawing object (i.e., background drawing objects a and b shown in FIG. 3 in step ST2 of FIG. 2). The gradation drawing unit can be alternatively constructed in such a way as to, in step ST2, generate two images of the background drawing object by repeating the process of step ST1 again, instead of making a copy of the background drawing object.

The gradation drawing unit draws the gradation target drawing object on one of the two images of the background drawing object which the gradation drawing unit generates in steps ST1 and ST2 to acquire a drawing object (referred to as a source image from here on). At this time, an antialiasing process is performed between the gradation target drawing object and the background drawing object (i.e., on the source image shown in FIG. 3 in step ST3 of FIG. 2). The gradation drawing unit then generates an alpha map (i.e., an alpha map of FIG. 3 in step ST4 of FIG. 2) in accordance with a gradation effect. In this case, the alpha map is a map in which a values respectively corresponding to pixels of the image are defined.

The gradation drawing unit combines the background drawing object generated in step ST2 and the source generated in step ST3 on the basis of the a values set to the alpha map generated in step ST4 to generate a drawing object (referred to as a destination image from here on) in which gradation is performed on the gradation target drawing object (i.e., a destination image shown in FIG. 3 in step ST5 of FIG. 2). A color value D′ for each image pixel is determined in accordance with the following equation (1).

D′≈S×255/α+D×(1−255/α) (1)

In this equation (1), D′ is the color value of each pixel of the destination image, S is the color value of the source image, and D is the color value of the background drawing object.

Because the gradation drawing unit, in step ST5, performs the gradation only on the gradation target drawing object, and therefore the two images located in a lower layer than the gradation target drawing object have the same color value, the combined result based on the equation (1) also has the same color value, and is not subjected to the gradation.

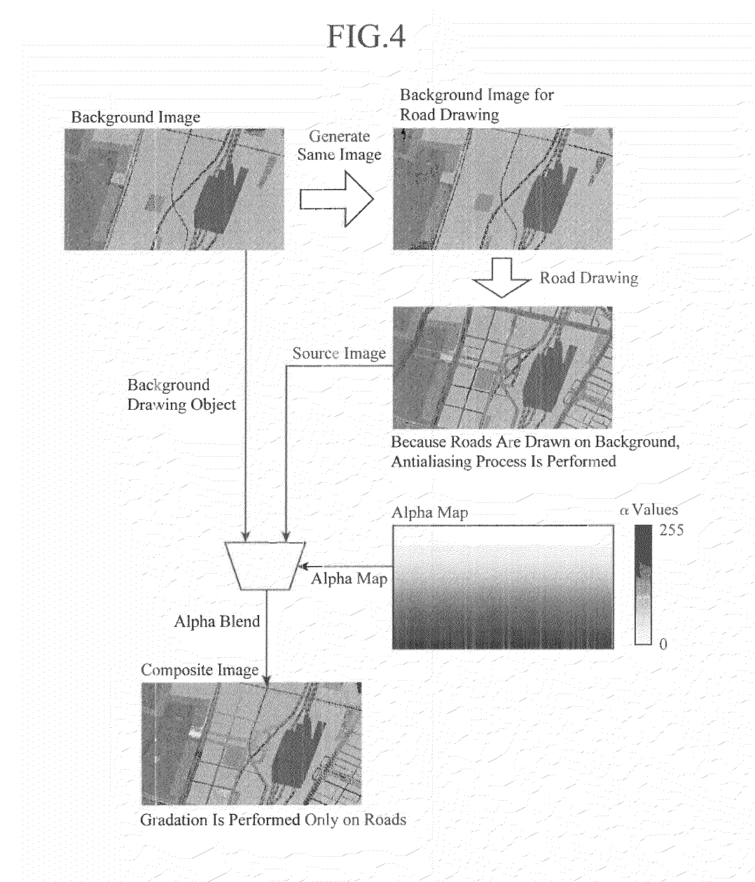

Next, a concrete process carried out by the gradation drawing unit 5 will be explained by using FIG. 4 and with reference to a flow chart of FIG. 2. Hereafter, a case in which the drawing object is a map and gradation is performed only on roads in the map will be shown. The gradation target drawing object is a road image, and the background drawing object is a background image.

The gradation drawing unit 5, in step ST1, draws a background image as the background drawing object, and, in step ST2, makes a copy of the background image or carries out the process of step ST1 again to generate a background image for road drawing. The gradation drawing unit then, in step ST3, draws a road image which is an object for gradation on the background image for road drawing to generate a source image, and also performs the antialiasing process between the background image and the road image. The gradation drawing unit, in step ST4, generates an alpha map in accordance with the gradation effect.

The gradation drawing unit, instep ST5, combines (alpha blends) the background image generated in steps ST1 and ST2, and the source image generated in step ST3 on the basis of the α values set to the alpha map to generate a composite image in which gradation is performed on the road image. As a result, the gradation drawing unit can generate an image in which gradation is performed only on roads which are the gradation target drawing object, as shown in the composite image of FIG. 4.

Although an image including roads and a background is explained as a concrete example shown in FIG. 4, the same gradation process can be implemented on any drawing object.

As mentioned above, the image drawing device in accordance with this Embodiment 1 generates two background drawing objects which are to be located in a lower layer than a gradation target drawing object, and draws the gradation target drawing object on one of the background drawing objects while combining them on the basis of an alpha map after performing an antialiasing process between them. Therefore, the image drawing device can perform gradation on the drawing object on which the image drawing device has performed the antialiasing process. As a result, the image drawing device can provide an image in which jaggies are not noticeable.

### INDUSTRIAL APPLICABILITY

Because an image drawing device and an image drawing method in accordance with the present invention can generate a gradation display of an image in which jaggies are not noticeable, the image drawing device and the image drawing method can be applied to a navigation device and so on, and can be used for provision of an image display which is easy to recognize visually.

1. A image drawing device comprising:
a gradation drawing unit for generating two background drawing objects which are to be located in a lower layer than a gradation target drawing object and drawing said gradation target drawing object on one of said background drawing objects while carrying out an antialiasing process between said one of the background drawing objects and said gradation target drawing object to generate a source image, and for combining said source image on a basis of an alpha map to generate a destination image.

2. A image drawing method comprising:
a drawing step of drawing a background drawing object to be located in a lower layer than a gradation target drawing object;
a copying/redrawing step of making a copy of said background drawing object or redrawing said background drawing object to generate two background drawing objects;
a source image generating step of drawing said gradation target drawing object on one of said background drawing objects while carrying out an antialiasing process between said one of said background drawing objects and said gradation target drawing object to generate a source image; and
a combining step of combining said source image on a basis of an alpha map to generate a destination image.
